(19) United States
(12) Patent Application Publication
(10) Pub. No.: US 2014/0071667 A1
(43) Pub. Date: Mar. 13, 2014

(54) STRAIGHT TUBE LAMP

(71) Applicants: Tadao Hayashi, Osaka-shi (JP); Yasuki Tsutsumi, Osaka-shi (JP)

(72) Inventors: Tadao Hayashi, Osaka-shi (JP); Yasuki Tsutsumi, Osaka-shi (JP)

(73) Assignee: SHARP KABUSHIKI KAISHA, Osaka-shi, Osaka (JP)

(21) Appl. No.: 14/115,078

(22) PCT Filed: May 9, 2012
(86) PCT No.: PCT/JP2012/061928

§ 371 Date: Oct. 31, 2013

(30) Foreign Application Priority Data
May 10, 2011 (JP) 2011-105580

(51) Int. Cl. F21V 29/00; F21V 21/005

(52) U.S. Cl. CPC F21V 29/22; F21V 21/005
USPC 362/218

(57) ABSTRACT

A straight tube lamp (100) includes: an LED substrate (1) having a plurality of LEDs (2) mounted thereon; a heat dissipating member (3), for dissipating heat from the LED substrate (1), to which the LED substrate (1) is attached; and a cylindrical case (6) which contains the heat dissipating member (3). A heat insulating member (4) is provided between the heat dissipating member (3) and the case (6).

### TECHNICAL FIELD

The present invention relates to a straight tube lamp. In particular, the present invention relates to a straight tube lamp that includes a solid-state light emitting element as a light source.

### BACKGROUND ART

As environmental awareness has grown in recent years, solid-state light emitting elements such as a laser diode and a light-emitting diode have been attracting attention as new light sources replacing conventional lamps such as an incandescent bulb and a fluorescent lamp. In particular, since a light-emitting diode (hereinafter referred to as LED) has a long life and high light conversion efficiency, LED lamps including LEDs as a light source have been attracting attention.

For example, Patent Literature 1 discloses a straight tube lamp that includes LEDs as a light source. The straight tube lamp is arranged such that (i) a rectangular substrate, on which the LEDs are mounted, is placed on top of a long heat dissipating member that extends along a longitudinal direction of the substrate and (ii) both the substrate and the heat dissipating member are contained in a case having a shape of a cylinder. The heat dissipating member is to dissipate heat that the LEDs generate while they are ON. Since there is provided the heat dissipating member and thereby heat generated in the LEDs is dissipated, it is possible to increase the life of the LEDs. In this arrangement, the heat dissipating member abuts against the inner surface of the case to ensure that the substrate is placed in a proper position relative to the case.

### CITATION LIST

### Patent Literature

Patent Literature 1
Japanese Patent Application Publication, Tokukai, No. 2010-123359 A (Publication Date: Jun. 3, 2010)

### SUMMARY OF INVENTION

### Technical Problem

However, the straight tube lamp of Patent Literature 1 is prone to warpage, for the following reason. That is, when the case is heated by the heat generated in the LEDs, one half of the cylinder rises in temperature more than the other half. As a result, both halves thermally expand to different degrees.

Usually, the case is made from a synthetic resin such as polycarbonate. Synthetic resins are advantageous in that they are less prone to breakages than glass etc., but are susceptible to thermal expansion. According to the straight tube lamp of Patent Literature 1, since the heat dissipating member is contained in the case, heat is less likely to be dissipated from the heat dissipating member as compared to a heat dissipating member that is outside of the case. Therefore, one half of the cylinder where the heat dissipating member is located undergoes a greater temperature rise than the other half where no heat dissipating member is provided. As a result, one half thermally expands to a greater extent than the other half, which results in warpage. In addition, according to the straight tube lamp of Patent Literature 1, the heat dissipating member abuts against the inner surface of the case. Therefore, one half where the heat dissipating member is located thermally expands to a greater extent, which results in a relatively-large warpage.

The straight tube lamp, which has warped, returns to its original state when the LEDs are turned OFF and thereby the temperature of the case decreases. However, if the straight tube lamp warps and returns to its original state again and again like this, there is a risk that it may detach from an illumination device to which it is attached. Specifically, in a case where the straight tube lamp is attached to a conventional fluorescent illumination device, end caps of the straight tube lamp on opposite ends along a longitudinal direction of the straight tube lamp are attached to sockets of the fluorescent illumination device. Each of the end caps has two terminals sticking out therefrom. The end caps are attached to the sockets by inserting the terminals into slots in the sockets. When the straight tube lamp warps and returns to its original state again and again, the connection between the terminals and the slots gradually becomes loose. At worst, the straight tube lamp detaches.

The present invention has been made in view of the above problems, and an object of the present invention is to provide a straight tube lamp that is less prone to warpage.

### Solution to Problem

In order to attain the above object, a straight tube lamp in accordance with the present invention includes: a substrate having a plurality of solid-state light emitting elements mounted thereon; a heat dissipating member for dissipating heat from the substrate; and a tubular case which contains the substrate and the heat dissipating member, said straight tube lamp further including a heat insulating member provided between the heat dissipating member and the case.

According to the arrangement, since the heat insulating member is provided between the heat dissipating member and the case, less heat is conducted from the heat dissipating member to the case. Therefore, even though the heat dissipating member is contained within the case, the temperature of the case on the backside (opposite side of the light-emitting side), where the heat dissipating member is located, does not increase that much. This makes it possible to reduce the occurrence of warpage attributed to a difference between degrees of thermal expansion of the backside and the light-emitting side of the case. In the following descriptions, warpage attributed to the difference between the degrees of thermal expansion of the backside and the light-emitting side is referred to as “thermal-expansion-induced warpage”.

### Advantageous Effects of Invention

According to the present invention, a heat insulating member is provided between a heat dissipating member and a case. With this arrangement, less heat is conducted from the heat dissipating member to the case. This makes it possible to suppress thermal-expansion-induced warpage of the case.

### BRIEF DESCRIPTION OF DRAWINGS

FIG. 1 is a cross-sectional view, which is taken along a longitudinal direction (along line A-A in FIG. 2), of a straight tube lamp according to one embodiment of the present invention.

FIG. 2 is a perspective view illustrating an external view of the straight tube lamp of the one embodiment.

FIG. 3, which illustrates the straight tube lamp of the one embodiment, is a cross-sectional view taken along line B-B in FIG. 1.

FIG. 4, which illustrates the straight tube lamp of the one embodiment, is a cross-sectional view taken along line C-C in FIG. 1.

FIG. 5, which illustrates a main part of the straight tube lamp of the one embodiment, is an exploded perspective view of the main part of the straight tube lamp.

FIG. 6 is an illustration of a region (range) irradiated by the straight tube lamp of the one embodiment.

FIG. 7, which shows a modified example of the straight tube lamp of the one embodiment, is an illustration of a cross section of a case whose wall has a nonuniform thickness.

FIG. 8 is a cross-sectional view, which is taken along a plane perpendicular to the longitudinal direction, of a straight tube lamp of another embodiment of the present invention. In FIG. 8, a cross section of a central portion and a cross section of an end portion are illustrated together.

FIG. 9 is a cross-sectional view, which is taken along a plane perpendicular to the longitudinal direction, of a heat insulating member of the straight tube lamp of the another embodiment.

FIG. 10, which shows a straight tube lamp of a further embodiment of the present invention, is a perspective view of a cross section of one of opposite ends of the straight tube lamp along the longitudinal direction.

### DESCRIPTION OF EMBODIMENTS

### Embodiment 1

The following description specifically discusses preferable embodiments of the present invention with reference to the drawings.

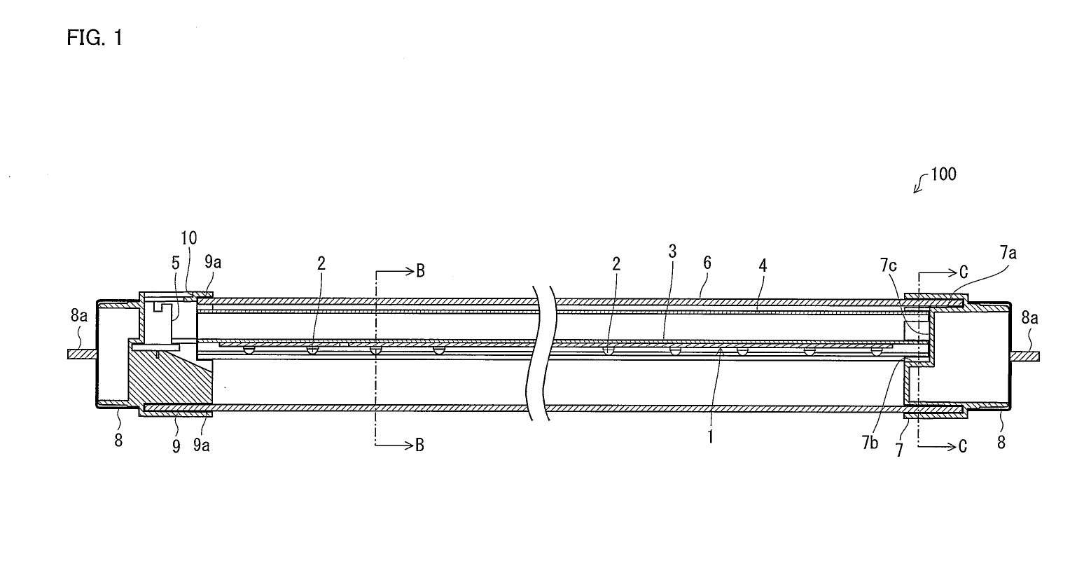

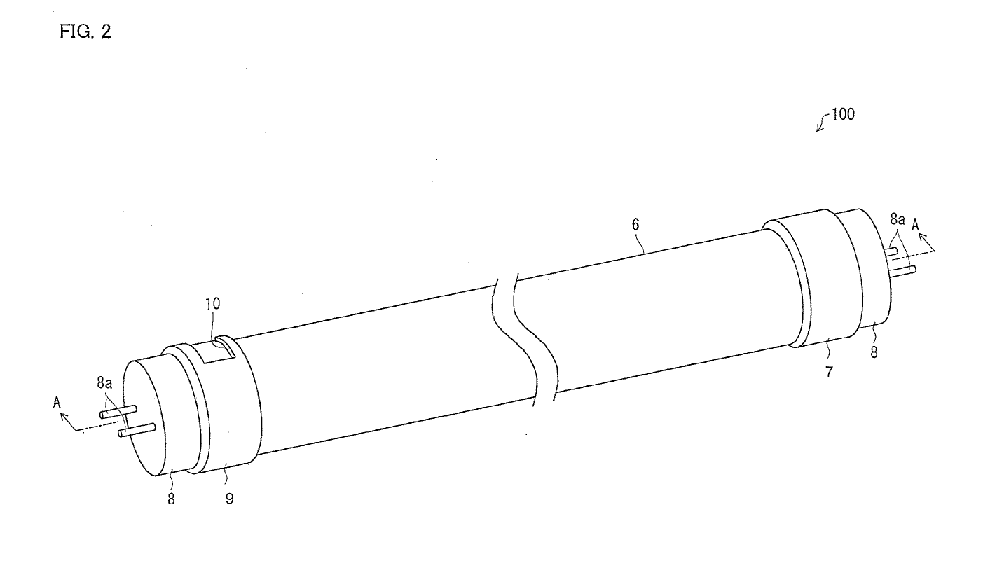

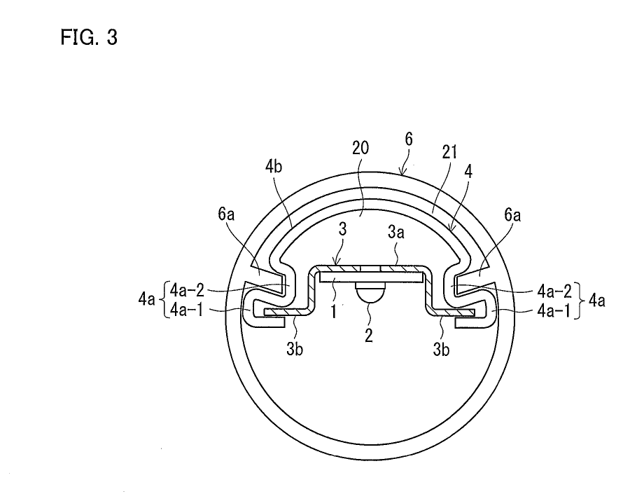

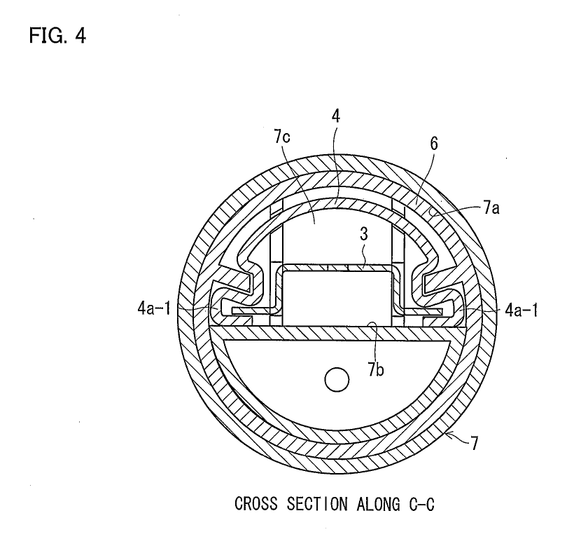

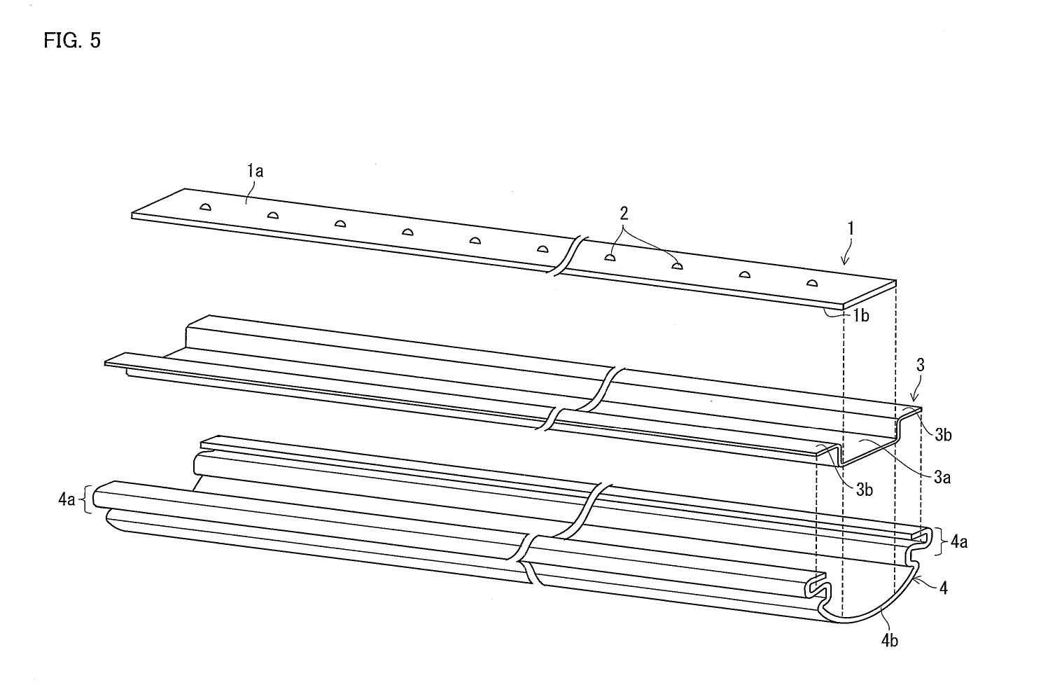

FIGS. 1 to 6 illustrate a straight tube lamp 100 of one embodiment in accordance with the present invention. Specifically, FIG. 2 is a perspective view illustrating an external view of the straight tube lamp 100, FIG. 1 is a cross-sectional view taken along line A-A in FIG. 2, FIG. 3 is a cross-sectional view taken along line B-B in FIG. 1, FIG. 4 is a cross-sectional view taken along line C-C in FIG. 1, and FIG. 5 is an exploded perspective view of a main part of the straight tube 100.

As illustrated in FIG. 1, the straight tube lamp 100 of the present embodiment includes a case 6, an LED substrate 1, a plurality of LEDs 2, a heat dissipating member 3, a heat insulating member 4, a connector section 5, a pair of joint sections 7 and 9, and a pair of end caps 8.

The case 6 is, as illustrated in FIGS. 1 to 3, in the shape of a straight-tube cylinder having a circular cross section, and contains therein the LED substrate 1, the heat dissipating member 3 and the heat insulating member 4. The case 6 is made from a light-transparent synthetic resin such as polycarbonate. Note that the shape of the case 6 is not limited to the straight-tube cylinder having a circular cross section, and therefore the case 6 may have an elliptic cross section. That is, it is only necessary that the case 6 have a tubular shape.

The LED substrate 1 is made from, for example, glass epoxy resin. As illustrated in FIG. 5, the LED substrate 1 is rectangular in shape, and has the plurality of LEDs 2 mounted on its first surface 1a. The LED substrate 1 further has wires thereon (not illustrated).

The plurality of LEDs 2 serve as a light source of the straight tube lamp 100. The plurality of LEDs 2 are arranged at predetermined intervals along a longitudinal direction of the LED substrate 1. The LEDs 2 are connected together with the wires (not illustrated). In the present embodiment, a predetermined number of LEDs 2 are connected in series to form a group, and such groups of LEDs 2 are connected in parallel to each other. Preferable examples of the LEDs 2 are surface-mount, packaged white LEDs.

The heat dissipating member 3 is a member to dissipate heat generated in the LEDs 2. In other words, the heat dissipating member 3 is a member to dissipate heat from the LED substrate 1. The heat dissipating member 3 is a long member that extends along the longitudinal direction of the LED substrate 1. As a material for the heat dissipating member 3, aluminum is often used, which is highly heat-conductive and is also lightweight. The LED substrate 1 is attached to the heat dissipating member 3 such that a second surface 1b of the LED substrate 1, which surface is opposite to the first surface 1a on which the LEDs 2 are mounted, is in contact with the heat dissipating member 3 so that the LED substrate 1 is stacked on the heat dissipating member 3. The LED substrate 1 here is attached to the heat dissipating member 3 with, for example, screws, rivets or the like (not illustrated).

As illustrated in FIG. 3, according to the present embodiment, the heat dissipating member 3 has, when cut along a plane perpendicular to the longitudinal direction, a cross section in the shape of a hat which includes (i) a U-shaped part 3a and (ii) flange parts 3b extending from respective opposite sides of the U-shaped part 3a. The LED substrate 1 is attached to the bottom of a recess defined by the U-shaped part 3a.

Since the heat dissipating member 3 has such a hat-shaped cross section and the LED substrate 1 is placed in the recess defined by the U-shaped part 3a of the heat dissipating member 3, low-color-temperature light (yellowish light) that travels diagonally from the LEDs 2 is blocked so that the color of light emitted from the straight tube lamp 100 is uniform.

This is described in more detail below. Of the light emitted from the LEDs 2, light that is emitted from a central portion of each of the LEDs 2 (i.e., light that travels along a direction normal to the LED substrate 1) is white and has a high color temperature. However, light that is emitted from a portion most distant from the central portion (i.e., light that travels diagonally) is yellowish and has a low color temperature. If such yellowish light goes out through the case 6, light emitted from the straight tube lamp 100 becomes partly yellowish. This is a problem.

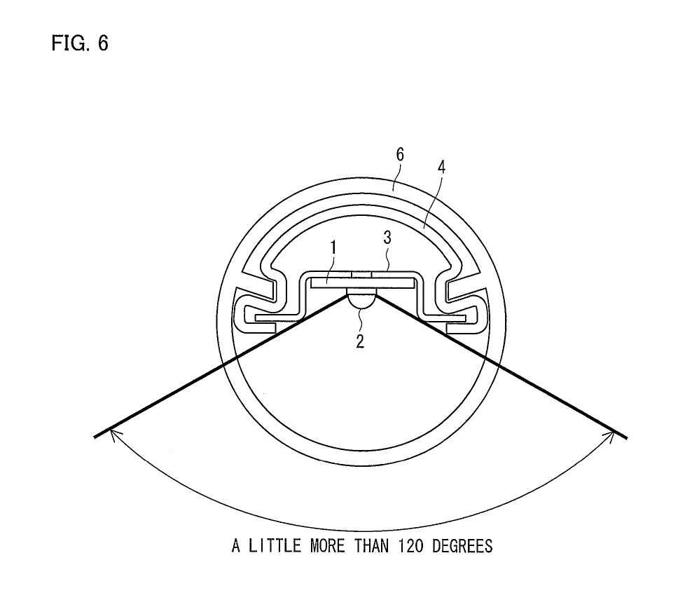

In view of the circumstances, as illustrated in FIG. 6, the heat dissipating member 3 has a hat-shaped cross section, and the LED substrate 1 is attached to the U-shaped part 3a of the heat dissipating member 3. With this arrangement, the low-color-temperature light that travels diagonally from the LEDs 2 is blocked by side walls of the U-shaped part 3a, and thereby the amount of low-color-temperature light that goes out through the case 6 is reduced. According to the present embodiment, the heat dissipating member 3 is designed such that the angular range, which includes the central portion, of light emission is a little more than 120 degrees. This design ensures that light emitted from the LEDs 2 to the outside is white.

Furthermore, since the heat dissipating member 3 having such a hat-shaped cross section has bent portions, the heat dissipating member 3 has a greater strength than a flat heat dissipating member that has the same thickness as the heat dissipating member 3 but does not have any bent portions. This leads to a greater rigidity of the straight tube lamp 100.

Specifically, as illustrated in FIG. 1, the heat dissipating member 3 extends over the almost entire length of the case 6 along the longitudinal direction of the case 6. Therefore, the heat dissipating member 3 serves also as a structural material of the straight tube lamp 100. Since the heat dissipating member 3 which also serves as a structural material has a high strength, the straight tube lamp 100 itself has a high rigidity.

It should be noted that, although FIG. 5 illustrates an arrangement in which a single LED substrate 1 has a length that is equivalent to the longitudinal length of the straight tube lamp 100, the LED substrate 1 may be constituted by a plurality of separate LED substrates, for easier production. In the case where the LED substrate 1 is constituted by a plurality of separate LED substrates, it is only necessary that the separate LED substrates be attached to the heat dissipating member 3 and be electrically connected with each other.

The heat insulating member 4 is, as illustrated in FIGS. 1, 3 and 5, provided between the heat dissipating member 3 and the case 6 so that less heat is conducted from the heat dissipating member 3 to the case 6 (preferably, heat is blocked).

As described earlier, the case 6 is made from a synthetic resin such as polycarbonate. Such a synthetic resin is prone to thermal expansion. Therefore, when one half of the cylinder (the case 6) where the heat dissipating member 3 is located rises in temperature more than the other half, both halves thermally expand to different degrees. This results in warpage. If the case 6 warps, then the straight tube lamp 100 warps.

Since there is provided the heat insulating member 4, less heat is conducted from the heat dissipating member 3 to the case 6 (preferably, heat is prevented from being conducted). This makes it possible to effectively avoid the following situation: one half of the case 6 where the heat dissipating member 3 is located thermally expands to a greater extent than the other half, and this results in warpage of the case 6.

The heat insulating member 4 may be made from a material that does not have rigidity. However, the heat insulating member 4 is preferably made from a material that has rigidity. Furthermore, to ensure insulating effects, it is most preferable that the heat insulating member 4 extends over the almost entire length of the case 6 along the longitudinal direction of the case 6, as with the heat dissipating member 3. Accordingly, the heat insulating member 4 having rigidity, which is provided so as to extend over the almost entire length of the case 6 along the longitudinal direction, can also serve as a structural material of the straight tube lamp 100 in the same manner as the heat dissipating member 3.

Since the heat insulating member 4 serves also as a structural material, the straight tube lamp 100 becomes more rigid. Furthermore, since such a rigid member is provided in a portion of the case 6 which portion thermally expands and causes warpage, even if the case 6 thermally expands and is about to cause warpage, the amount of such warpage is suppressed by the rigidity of the heat insulating member 4.

The heat insulating member 4 which has rigidity is made from, for example, a synthetic resin such as polycarbonate (which is the same as the material for the case 6). Note, however, that the heat insulating member 4 is different from the case 6 in that it does not have to be light-transparent. Therefore, the material for the heat insulating member 4 is not limited, provided that it is highly heat-insulating, lightweight and has the necessary level of rigidity.

The following description discusses, with reference to FIGS. 1, 3 and 5, details of (i) the shape of the heat insulating member 4 and (ii) how the heat insulating member 4 and the heat dissipating member 3 are attached to the case 6, in the straight tube lamp 100 of the present embodiment.

As illustrated in FIG. 5, the heat insulating member 4 is a long member that extends along the longitudinal direction of the LED substrate 1, as with the heat dissipating member 3. In the present embodiment, the heat insulating member 4 is a molded member produced by, for example, bending a long, thin resin plate. The heat insulating member 4 has, when cut along a plane perpendicular to the longitudinal direction, a cross section including (i) a curved part 4b having a shape that matches the inner peripheral surface (inner surface) of the case 6 and (ii) S-shaped parts 4a, on respective opposite sides of the curved part 4b, each of which is bent into S-shape. Such a heat insulating member 4 is formed by extrusion molding of a synthetic resin such as polycarbonate.

As illustrated in FIG. 3, the curved part 4b of the heat insulating member 4 is positioned between the heat dissipating member 3 and the case 6. With this arrangement, an air space 20 is formed between the curved part 4b and the heat dissipating member 3, and an air space 21 is formed between the curved part 4b and the case 6. The air spaces 20 and 21 also serve as heat insulating layers. That is, the heat insulating member 4 of the present embodiment is configured such that (i) the heat insulating member 4 itself serves as a heat insulating layer and (ii) the heat insulating member 4 also creates the air spaces 20 and 21 which serve as heat insulating layers. This achieves a light-weight heat insulating member 4 that brings about a great heat insulating effect. It should be noted that, although the description here deals with an arrangement in which two air spaces 20 and 21 are formed, the heat insulating member 4 may be configured such that an air space is formed between (i) the curved part 4b and the heat dissipating member 3 and/or (ii) the curved part 4b and the case 6.

Furthermore, according to the present embodiment, a part (i.e., the curved part 4b) of the heat insulating member 4, which part is positioned between the heat dissipating member 3 and the case 6, has a shape that matches the inner peripheral surface of the case 6. With this arrangement, the case 6 has a structure like a double-walled structure in a part where there is the curved part 4b. This increases strength for prevention of warpage of the case 6, and thus makes it possible to more effectively reduce the occurrence of thermal-expansion-induced warpage of the case 6.

Furthermore, since the U-shaped part 3a is placed so that it protrudes in the same direction as the curved part 4b which has a shape that matches the inner peripheral surface of the case 6, the following is achieved. That is, the air space 20 is necessarily formed between the curved part 4b (curved surface) and the bottom (flat surface) of the U-shaped part 3a. In addition, since the LEDs 2 are placed at the bottom of the recess defined by the U-shaped part 3a, the LEDs 2 are sufficiently distant from the case 6 so that light from the LEDs 2 is thoroughly diffused by the case 6 and thus uniform light is emitted to the outside.

It should be noted that the shape of the part of the heat insulating member 4, which part is positioned between the heat dissipating member 3 and the case 6, is not limited to the above. The part of the heat insulating member 4 may have, for example, a flat portion at the top of the curved part 4b. This makes it possible to increase the amount of the air space formed between the heat insulating member 4 and the case 6. Note, however, that the following arrangement achieves the greatest strength for prevention of warpage of the case 6: the part which is positioned between the heat dissipating member 3 and the case 6 is the curved part 4b which has a shape that matches the inner peripheral surface of the case 6, and thereby the case 6 has a structure like a double-walled structure.

Each of the S-shaped parts 4a includes, specifically, a holding part 4a-1 and a fastening part 4a-2 (see FIG. 3). The fastening part 4a-2 is continuous with the curved part 4b, and is bent into U-shape so as to protrude toward the center axis of the curved part 4b (when the heat insulating member 4 is inside the case 6, the fastening part 4a-2 protrudes toward the center axis of the case 6). On the other hand, the holding part 4a-1 is continuous with the fastening part 4a-2, and its opposite sides, each of which extends along the longitudinal direction of the heat insulating member 4, are folded inward toward the center axis of the curved part 4b. That is, the holding part 4a-1 is bent into U-shape so as to protrude in a direction going away from the center axis of the curved part 4b.

The fastening part 4a-2 is designed to, while the heat insulating member 4 is inside the case 6, fasten the heat insulating member 4 to the case 6 and also restrain movement of the heat insulating member 4 in a circumferential direction along the inner surface (inner peripheral surface) of the case 6. The inner surface of the case 6 has ribs (protrusions) 6a which protrude toward the center axis of the case 6 so as to make a pair. The ribs 6a are engaged with respective fastening parts 4a-2, whereby the heat insulating member 4 is fastened to the case 6 and also the movement of the heat insulating member 4 in the circumferential direction along the inner surface of the case 6 is restrained.

In order to reduce the amount of heat conducted to the case 6 to the smallest amount, it is preferable that the contact between the heat insulating member 4 and the case 6 is avoided as much as possible. According to the present embodiment, the heat insulating member 4 and the case 6 are in contact with (abut on) each other only at the fastening parts 4a-2 and the ribs 6a.

The ribs 6a may be provided so as to make a pair and be flush with a plane parallel to the center axis of the case 6. Furthermore, the fastening parts 4a-2 can be arranged such that (i) a gap defined by a U-shaped part of a fastening part 4a-2 is a little smaller than the thickness of a corresponding rib 6a so that the fastening part 4a-2 serves as a plate spring and (ii) the fastening part 4a-2 forcibly sandwiches the rib 6a.

The holding part 4a-1 supports the heat dissipating member 3. The heat dissipating member 3's opposite sides, each of which extends along the longitudinal direction of the case 6, are held by the heat insulating member 4's opposite sides each of which extends along the longitudinal direction. Specifically, since the flange parts 3b on the opposite sides of the heat dissipating member 3, each of which extends along the longitudinal direction, are supported by respective holding parts 4a-1 of the heat insulating member 4, the heat dissipating member 3 is contained in the case 6 in such a manner that it is not in contact with the case 6. It is preferable that the holding parts 4a-1 are arranged such that (i) a gap defined by a U-shaped part of a holding part 4a-1 is a little smaller than the thickness of a corresponding flange part 3b so that the holding part 4a-1 serves as a plate spring and (ii) the holding part 4a-1 sandwiches the flange part 3a.

With this arrangement, it is possible to handle the heat dissipating member 3 and the heat insulating member 4 as a single member. That is, by inserting the heat insulating member 4, which has the heat dissipating member 3 attached thereto, into the case 6 such that the ribs 6a on the inner surface of the case 6 fit the respective fastening parts 4a-2, it is possible to attach the heat dissipating member 3 and the heat insulating member 4 to the inside of the case 6 at a time.

Since the heat insulating member 4 also has bent portions (i.e., S-shaped parts 4a) as described above, the heat insulating member 4 has a greater strength than a flat heat insulating member that has the same thickness as the heat insulating member 4 but does not have any bent portions. This increases the apparent strength of the case 6, and also increases the rigidity of the straight tube lamp 100.

Furthermore, as described earlier, it is most preferable that the heat insulating member 4 extends over the almost entire length of the case 6 along the longitudinal direction of the case 6. However, for reasons of acceptable total weight of the straight tube lamp 100, there may be no choice but to provide the heat insulating member 4 to only part of the length of the case 6. If this is the case, the heat insulating member 4 is preferably provided in a central portion of the case 6 in the longitudinal direction, in which portion a force to cause warpage is likely to concentrate.

The joint sections 7 and 9 are end members attached to the case 6 at opposite ends of the case 6 along the longitudinal direction (i.e., a direction parallel to the center axis). The joint sections 7 and 9 are attached to the opposite ends, along the longitudinal direction, of the case 6 which contains therein the LED substrate 1, the heat dissipating member 3 and the heat insulating member 4. The joint sections 7 and 9 have circular slots 7a and 9a, respectively, which match the shapes of surfaces of the opposite ends of the case 6 along the longitudinal direction. The opposite ends of the case 6 along the longitudinal direction are fitted into the circular slots 7a and 9a, respectively, whereby the joint sections 7 and 9 are attached to the opposite ends of the case 6.

The heat insulating member 4, which has the heat dissipating member 3 attached thereto, is restrained by the joint sections 7 and 9 such that its movement relative to the case 6 along the longitudinal direction of the case 6 is restrained.

Specifically, as illustrated in FIGS. 1 and 4, a horizontal end surface 7b of the joint section 7 abuts on the holding parts 4a-1 of the heat insulating member 4 so that one of the opposite ends of the heat insulating member 4 along the longitudinal direction is held by the joint section 7. Furthermore, a vertical end surface 7c of the joint section 7 abuts on the one of the opposite ends of the heat insulating member 4 along the longitudinal direction and one of the opposite ends of the heat dissipating member 3 along the longitudinal direction such that these ends abut against the vertical end surface 7c.

As with the joint section 7, the joint section 9 also has (i) a first part that abuts on the holding parts 4a-1 of the heat insulating member 4 so that the other of the opposite ends of the heat insulating member 4 along the longitudinal direction is held by the joint section 9 and (ii) a second part that abuts on the other of the opposite ends of the heat insulating member 4 along the longitudinal direction and the other of the opposite ends of the heat dissipating member 3 along the longitudinal direction such that these ends abut against the joint section 9 (this arrangement is not illustrated in FIG. 1).

The opposite ends of the heat insulating member 4 along the longitudinal direction and the opposite ends of the heat dissipating member 3 along the longitudinal direction are restrained by the horizontal end surface 7b and the vertical end surface 7c of the joint section 7 and the first and second parts of the joint section 9, whereby the movement of the heat insulating member 4 and the heat dissipating member 3 along the longitudinal direction of the case 6 is restrained. In this way, the heat insulating member 4 and the heat dissipating member 3 are held in place by the joint sections 7 and 9.

In a case where the heat dissipating member 3 is fixed to the heat insulating member 4 so that it does not move relative to the heat insulating member 4, it is only necessary that the opposite ends of the heat insulating member 4 along the longitudinal direction be held by the joint sections so that the movement of the heat insulating member 4 along the longitudinal direction of the case 6 is restrained and that the heat insulating member 4 is held in place.

Note that the above arrangement, in which the opposite ends of the heat insulating member 4 along the longitudinal direction and the opposite ends of the heat dissipating member 3 along the longitudinal direction are held in place by the joint sections (end members), will be described in more detail in Embodiment 3.

The connector section 5 is, as illustrated in FIG. 1, attached to the inside of the joint section 9 where electric power is received. The connector section 5 and the LED substrate 1 are electrically connected with each other. The joint section 9 has an opening 10 through which the connector section 5 can be connected, through a wire, to a power source included in an illumination device.

The end caps 8 are attached to the respective joint sections 7 and 9. Each of the end caps 8 has two terminals 8a sticking out therefrom. Since the straight tube lamp 100 of the present embodiment receives electric power via the connector section 5 and the electric power is supplied to the LED substrate 1, the terminals 8a are not used to receive electric power. Instead, they are used to attach the straight tube lamp 100 to an illumination device.

It should be noted that the configurations of the joint sections 7 and 9 are not limited to the above. The joint sections 7 and 9 may be configured such that they have no connector section 5 and that the straight tube lamp 100 can be used in a conventional fluorescent illumination device in place of a straight tube fluorescent lamp. That is, the joint sections 7 and 9 may be configured such that they are suitable for use in an arrangement in which the terminals 8a of the end caps 8 are inserted into sockets of the fluorescent illumination device and thereby the straight tube lamp is mechanically attached and electrically connected to the fluorescent illumination device. Alternatively, the joint sections 7 and 9 can be arranged such that they are suitable for use in a straight tube lamp which contains a power source.

As has been described, the straight tube lamp of the present embodiment is arranged such that the heat insulating member 4 is provided between the case 6 and the heat dissipating member 3. The heat insulating member 4 is to reduce (preferably, block) heat that is conducted from the heat dissipating member 3 to the case 6.

With this arrangement, less heat is conducted from the heat dissipating member 3 to the case 6 (preferably, heat is prevented from being conducted). This makes it possible to effectively reduce the likelihood that one half of the cylinder (the case 6) where the heat dissipating member 3 is located thermally expands more than the other half and thereby the case 6 warps. Accordingly, it is possible to realize a straight tube lamp 100 that (i) is arranged such that the heat dissipating member 3 is contained in the case 6 but (ii) is less prone to warpage.

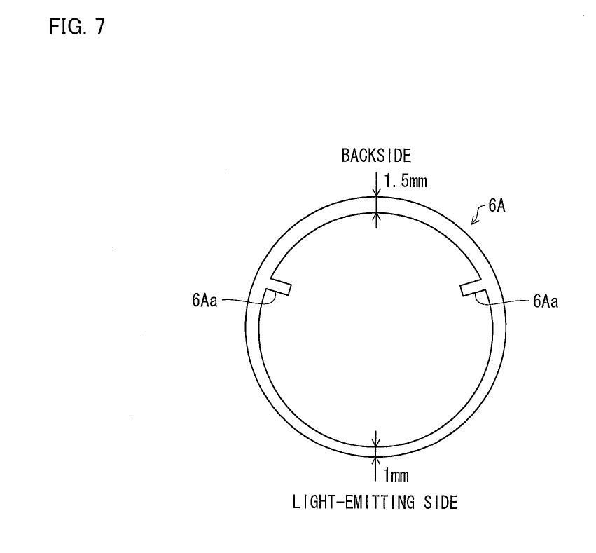

The straight tube lamp 100 more preferably includes a case 6A whose wall has a nonuniform thickness, instead of the case 6. The wall of the case 6A is thinner on the light-emitting side (see FIG. 7). For example, the thickness of the wall on the light-emitting side is 1.0 mm, whereas the thickness of the wall on the backside is 1.5 mm. According to this arrangement, since the wall on the light-emitting side is thinner, a larger amount of light travels to the outside and thus light use efficiency is increased. Furthermore, since the wall on the backside (where the degree of thermal expansion is larger than the light-emitting side) is thicker, the case 6A has a greater strength and thus becomes less prone to thermal-expansion-induced warpage. In a case where the thickness of the wall on the light-emitting side is reduced without changing the thickness of the wall on the backside, light use efficiency is improved and also weight is reduced.

As is clear from above, in a case where the straight tube lamp 100 of the present embodiment includes, instead of the case 6, the case 6A whose wall has a non-uniform thickness and which brings about the above effects, it is possible to even more effectively reduce the occurrence of warpage.

Furthermore, as described earlier, there may be no choice but to provide the heat insulating member 4 to only part of the longitudinal length of the heat dissipating member 3, for reasons of acceptable total weight of the straight tube lamp 100. Even in this case, the case 6A may make it possible to provide the heat insulating member 4 which extends over the entire longitudinal length of the heat dissipating member 3, because the case 6A whose wall has a non-uniform thickness has a reduced weight. Therefore, a combination of the case 6A and the heat insulating member extending over the entire longitudinal length of the heat dissipating member 3 is very advantageous.

### Embodiment 2

The following description will specifically discuss, with reference to the drawings, another embodiment of the present invention. For convenience of description, members having functions identical to those included in Embodiment 1 are assigned identical referential numerals, and their descriptions are omitted here.

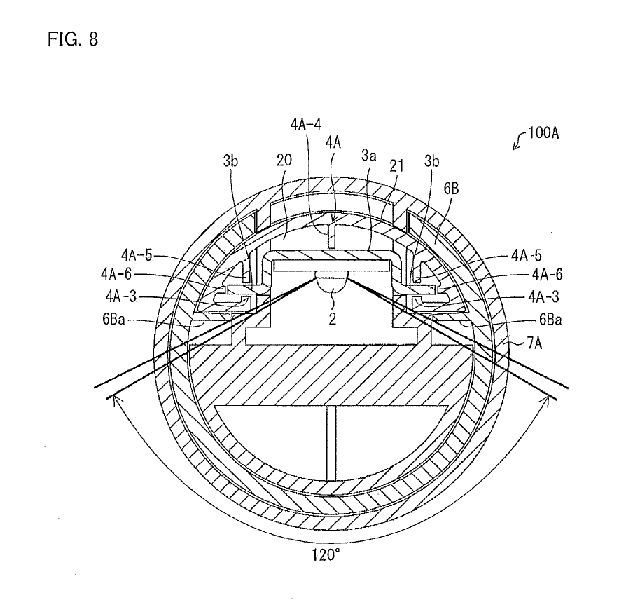

FIG. 8 is a cross-sectional view of a straight tube lamp 100A of the another embodiment of the present invention. In FIG. 8, the following (i) and (ii) are illustrated together: (i) a cross section of a central portion of the straight tube lamp 100A where the LEDs 2 are provided (this cross section corresponds to FIG. 3 of Embodiment 1) and (ii) a cross section of a joint section 7 of the straight tube lamp 100A (this cross section corresponds to FIG. 4 of Embodiment 1.

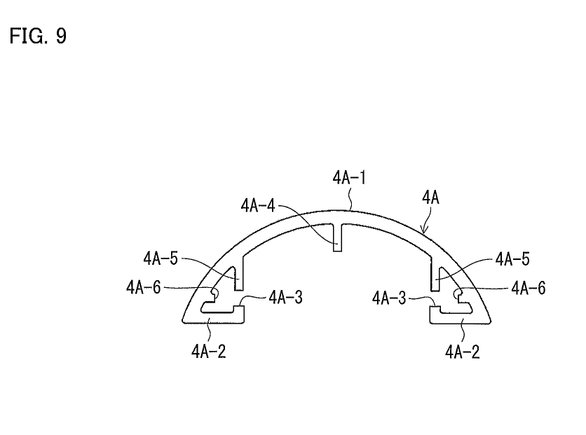

The straight tube lamp 100A of the present embodiment is different from the straight tube lamp 100 of Embodiment 1 mainly in the shape of the heat insulating member. The straight tube lamp 100A of the present embodiment includes a heat insulating member 4A, which is a long member having a cross section in the shape of a partial circle when cut along a plane perpendicular to the longitudinal direction (see FIG. 9).

As illustrated in FIGS. 8 and 9, the heat insulating member 4A is a molded member produced by, for example, bending a long, thin resin plate. The heat insulating member 4A has, when cut along a plane perpendicular to the longitudinal direction, a cross section including (i) an arc-shaped part 4A-1 having a shape that matches the inner peripheral surface (inner surface) of the case 6B, (ii) fastening parts 4A-2 which are end portions of the arc-shaped part 4A-1 folded toward the center axis of the arc-shaped part 4A-1 so as to be horizontal, (iii) holding parts 4A-3 which are the ends of the respective fastening parts 4A-2 folded toward the arc-shaped part 4A-1, (iv) holding parts 4A-5 each of which protrudes vertically downward from the inner surface of the arc-shaped part 4A-1, (v) holding parts 4A-6 each of which protrudes from the inner surface of the arc-shaped part 4A-1 so as to be parallel to the fastening parts 4A-2, and (vi) a guide wall 4A-4 which protrudes vertically downward from the inner surface of the arc-shaped part 4A-1. Such a heat insulating member 4A is formed by extrusion molding of a synthetic resin such as polycarbonate.

As illustrated in FIG. 8, the arc-shaped part 4A-1 of the heat insulating member 4A is positioned between the heat dissipating member 3 and the case 6B. With this arrangement, an air space 20 is formed between the arc-shaped part 4A-1 and the heat dissipating member 3, and an air space 21 is formed between the curved part 4b and the case 6B. The air spaces 20 and 21 also serve as heat insulating layers. Note however that, since the arc-shaped part 4A-1 is near the inner surface of the case 6B in the present embodiment, the air space 20 is smaller than that in Embodiment 1. It should be noted that, although the description here deals with an arrangement in which two air spaces 20 and 21 are formed, the heat insulating member 4A may be arranged such that an air space is formed (i) between the arc-shaped part 4A-1 and the heat dissipating member 3 and/or (ii) between the curved part 4b and the case 6B.

The heat dissipating member 3 is, as illustrated in FIG. 8, held by the heat insulating member 4A such that flange parts 3b of the heat dissipating member 3 are held by a pair of holding parts 4A-3, a pair of holding parts 4A-50 and a pair of holding parts 4A-6. That is, also in this arrangement, the heat dissipating member 3's opposite sides, each of which extends along the longitudinal direction of the case 6B, are held by the heat insulating member 4A's opposite sides, each of which extends along the longitudinal direction.

The guide wall 4A-4 guides the U-shaped part 3a of the heat dissipating member 3. The heat dissipating member 3 is inserted, from one of the opposite ends of the heat insulating member 4A along the longitudinal direction, into the heat insulating member 4A and attached to the heat insulating member 4A such that the flange parts 3b of the heat dissipating member 3 are positioned in respective spaces each of which is defined by three holding parts 4A-3, 4A-5 and 4A-6 facing a common point. The guide wall 4A-4 serves as a guide when the heat dissipating member 3 is inserted.

The holding parts 4A-3, 4A-5 and 4A-6 and the guide wall 4A-4 also serve as (i) spacers positioned between the heat dissipating member 3 and the heat insulating member 4A to form the air space 20 and (ii) positioning parts to position the heat insulating member 4A relative to the heat dissipating member 3. With this arrangement, the air space is necessarily formed and also the heat dissipating member 3 is stably held to the heat insulating member 4A.

The heat insulating member 4A, which has the heat dissipating member 3 attached thereto, is attached to the case 6 by being inserted into the case 6B such that ribs 6Ba on the inner surface of the case 6B fit the respective fastening parts 4A-2.

Since the heat insulating member 4B has the fastening parts 4A-2, the holding parts 4A-5, the holding parts 4A-6 and the guide wall 4A-4 as described above, the heat insulating member 4A has a greater strength than a flat heat insulating member that has the same thickness as the heat insulating member 4A but does not have any bent portions. This increases the strength for prevention of warpage of the case 6B, and also increases the rigidity of the straight tube lamp 100A.

### Embodiment 3

The following description will specifically discuss, with reference to the drawings, a further embodiment of the present invention. For convenience of description, members having functions identical to those included in Embodiments 1 and 2 are assigned identical referential numerals, and their descriptions are omitted here.

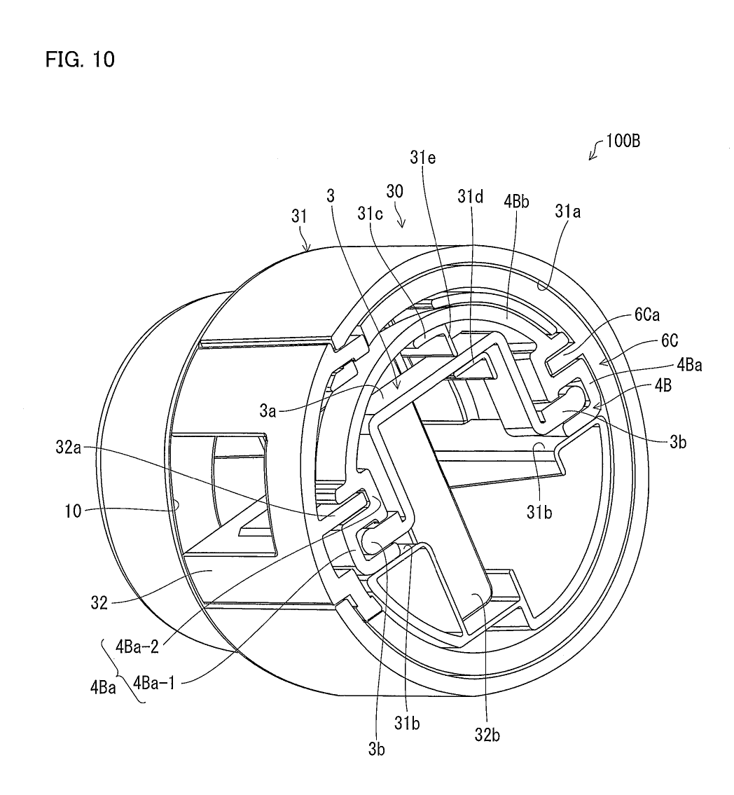

FIG. 10 is a perspective view illustrating a cross section of one of opposite ends, along the longitudinal direction, of a straight tube lamp 100B of the further embodiment of the present invention. The straight tube lamp 100B includes a joint section 30 which is attached to one of opposite ends of a case 6C along the longitudinal direction. The joint section 30 includes a main body 31 and a connector cover 32. The main body 31 and the connector cover 32 fit together. The connector cover 32 holds the aforementioned connector which is provided to receive electric power, and serves as part of the joint section 30 when the connector cover 32 and the main body 31 fit together. The connector cover 32 has an opening 10 through which a wire is to pass, through which wire the connector held inside is connected to a power source included in an illumination device. Note that, although the present embodiment deals with an arrangement in which the main body 31 and the connector cover 32 that is separate from the main body 31 are provided to hold the connector, the main body 31 and the connector cover 32 may be integral with each other.

One of the opposite ends of the case 6C along the longitudinal direction is fitted into a circular slot 31a in the main body 31 of the joint section 30, whereby the joint section 30 is attached to the case 6C. The one of the opposite ends of the case 6C along the longitudinal direction has a cut along a circumferential direction. The cut corresponds to the shape of a part of the main body 31, in which part the connector cover 32 is fitted.

According to the present embodiment, a heat insulating member 4B has, when cut along a plane perpendicular to the longitudinal direction, a cross section including (i) a curved part 4Bb which has a shape that matches the shape of an inner peripheral surface (inner surface) of the case 6C and (ii) 5-shaped parts 4Ba which are provided on opposite sides of the curved part 4Bb and each of which is curved in the shape of “5”. The heat insulating member 4B is also formed by extrusion molding of a synthetic resin such as polycarbonate.

The curved part 4Bb of the heat insulating member 4B has the same function as that of the curved part 4b of the heat insulating member 4 of Embodiment 1. The 5-shaped parts 4Ba of the heat insulating member 4B have the same function as the S-shaped parts 4a of the heat insulating member 4. That is, (i) a holding part 4Ba-1 and a fastening part 4Ba-2 of each of the 5-shaped parts 4Ba correspond to the holding part 4a-1 and the fastening part 4a-2 of each of the S-shaped parts 4a, respectively, (ii) the holding parts 4Ba-1 on opposite sides of the heat insulating member 4B hold the respective flange parts 3b of the heat dissipating member 3, and (iii) the fastening parts 4Ba-2 on the opposite sides of the heat insulating member 4B are engaged with ribs 6Ca on the case 6C.

With this arrangement, the heat insulating member 4B and the heat dissipating member 3 that is held on the heat insulating member 4B are restrained such that their movement along a circumferential direction (i.e., along the inner surface of the case 6C) is restrained. As described earlier, the case 6C has a cut in a part in which the connector cover 32 is fitted. Therefore, the connector cover 32 has a rib 32a, which serves as a rib 6Ca that is supposed to be in the part where the cut is made. In a part of the joint section 30 in which part the connector cover 32 is fitted, the fastening part 4Ba-2 of the heat insulating member 4B is engaged with the rib 32a.

Furthermore, the heat insulating member 4B and the heat dissipating member 3 that is held on the heat insulating member 4B are held in place, and their movement along the longitudinal direction of the case 6C is restrained, by supporting parts 31b, a supporting part 31c, a supporting part 31d, a tension part 31e and an abutting part 32b of the joint section 30.

Specifically, the supporting parts 31b of the main body 31 of the joint section 30 abut, from a side opposite to a bottom side of the recess defined by the U-shaped part 3a of the heat dissipating member 3, on the holding parts 4Ba-1 on the respective opposite sides of the heat insulating member 4B. The supporting parts 31c and 31d of the main body 31 abut, from the side opposite to the bottom side of the recess defined by the U-shaped part 3a of the heat dissipating member 3, on the curved part 4Bb of the heat insulating member 4B and the U-shaped part 3a of the heat dissipating member 3, respectively. Furthermore, the tension part 31e of the main body 31, which part is positioned between the curved part 4Bb of the heat insulating member 4B and the U-shaped part 3a of the heat dissipating member 3, applies tension to the heat insulating member 4B and the heat dissipating member 3 so that the distance between the heat insulating member 4B and the heat dissipating member is increased. Moreover, the abutting part 32b of the connector cover 32 of the joint section 30 abuts on one of the opposite ends of the heat insulating member 4B along the longitudinal direction such that the abutting part 32b abuts against the one of the opposite ends. The abutting part 32b has a flat abutting surface that is perpendicular to the center axis of the case 6C.

The other of the opposite ends of the straight tube lamp 100B along the longitudinal direction also has a joint section (not illustrated), which is the same as the joint section 30 in that it has the supporting parts 31b, 31c and 31d, the tension part 31e and the abutting part 32b but is different from the joint section 30 only in that it does not have the members associated with the connector section. The case 6C, which contains therein the heat insulating member 4B and the heat dissipating member 3, is sandwiched between these two joint sections, whereby the opposite ends of the heat insulating member 4 along the longitudinal direction and the opposite ends of the heat dissipating member 3 along the longitudinal direction are held in place.

Note that, in a case where the heat dissipating member 3 is fixed to the heat insulating member 4B so that the heat dissipating member 3 does not move relative to the heat insulating member 4B, it is only necessary that the opposite ends of the heat insulating member 4B along the longitudinal direction be held in place by the joint sections.

The straight tube lamp of the present invention is preferably arranged such that the heat dissipating member is held by the heat insulating member so that the heat dissipating member is not in contact with the case.

Since the heat dissipating member is not in contact with the case, it is possible to effectively reduce heat that is conducted from the heat dissipating member to the case, and thus possible to even more effectively suppress the foregoing thermal-expansion-induced warpage.

The above arrangement can be easily realized by, for example, employing an arrangement in which opposite sides, each of which extends along a longitudinal direction of the case, of the heat dissipating member are held by opposite sides, each of which extends along the longitudinal direction, of the heat insulating member.

The straight tube lamp of the present invention can be arranged such that: the heat insulating member has a part that is positioned between the heat dissipating member and the case; and an air space is formed (i) between the heat insulating member and the heat dissipating member and/or (ii) between the heat insulating member and the case.

The air space(s) (i) between the heat insulating member and the heat dissipating member and/or (ii) between the heat insulating member and the case serve(s) as a heat insulating layer(s). Therefore, according to the arrangement, the heat insulating member not only has the function of a heat insulating layer but also brings about a heat insulation effect by forming the air spaces. This makes it possible to achieve a great heat insulation effect while keeping a reduced weight of the heat insulating member.

The straight tube lamp of the present invention is preferably arranged such that movement of the heat insulating member in a circumferential direction along an inner surface of the case is restrained and the heat insulating member is fastened to the case, by (i) protrusions which protrude from the inner surface of the case so as to make a pair and be flush with a plane parallel to a center axis of the case or (ii) protrusions which protrude toward the center axis of the case so as to make a pair.

Since the area of contact between the heat insulating member which holds the heat dissipating member thereon and the inner surface of the case is reduced as much as possible, less heat is conducted from the heat insulating member to the case. According to the above arrangement, the heat insulating member is fastened with the protrusions on the inner surface of the case, and thereby the movement of the heat insulating member in the circumferential direction along the inner surface of the case is restrained. This makes it possible to reduce heat conducted from the heat insulating member to the case. This also makes it possible to easily assemble the heat dissipating member and the heat insulating member to the case, and thus possible to easily produce the straight tube lamp. Furthermore, it is possible to easily disassemble the straight tube lamp when recycling it.

The straight tube lamp of the present invention is preferably arranged such that: the case has end members attached to its opposite ends along the longitudinal direction; and the end members restrain movement of the heat insulating member relative to the case along the longitudinal direction.

According to the arrangement, the movement of the heat insulating member along the longitudinal direction of the case is restrained by the end members attached to the opposite ends of the case, which end members sandwich the heat insulating member between them. Therefore, it is easy to assemble these members to the case, and is also easy to disassemble the straight tube lamp when recycling it.

The straight tube lamp of the present invention is preferably arranged such that the part of the heat insulating member, which part is positioned between the heat dissipating member and the case, has a shape that matches an inner peripheral surface of the case.

According to the above arrangement, because of the part of the heat insulating member which part is positioned between the heat dissipating member and the case, the case has a structure like a double-walled structure. This increases the strength of the case, and makes it possible to more effectively suppress the foregoing warpage.

The straight tube lamp of the present invention is preferably arranged such that: the heat dissipating member has, when cut along a plane perpendicular to the longitudinal direction of the case, a hat-shaped cross section including (i) a U-shaped part and (ii) flange parts on respective opposite sides of the U-shaped part; and the substrate is attached to the bottom of a recess defined by the U-shaped part.

According to the arrangement, low-color-temperature light that travels diagonally from the solid-state light emitting elements is blocked by the U-shaped part. This makes it possible to cause the straight tube lamp to emit light having a uniform color.

The straight tube lamp of the present invention can be arranged such that a wall of the case is thinner on a light-emitting side than on a backside.

Since the wall on the light-emitting side is thinner, a larger amount of light travels to the outside and thus light use efficiency is increased. Furthermore, since the wall on the backside (which thermally expands to a greater extent than the light-emitting side) is thicker, the case has a greater strength and thus becomes less prone to thermal-expansion-induced warpage. In a case where the thickness of the wall on the light-emitting side is reduced without changing the thickness of the wall on the backside, light use efficiency is improved and also weight is reduced.

The present invention is not limited to the descriptions of the respective embodiments, but may be altered within the scope of the claims. An embodiment derived from a proper combination of technical means disclosed in different embodiments is encompassed in the technical scope of the invention.

### REFERENCE SIGNS LIST

1 LED substrate
2 LED
3 Heat dissipating member
3a U-shaped part
3b Flange part
4 Heat insulating member
4A Heat insulating member
4A-1 Arc-shaped part
4A-2 Fastening part
4A-3 Holding part
4A-4 Guide wall
4A-5 Holding part
4A-6 Holding part
4a S-shaped part
4a-1 Holding part
4a-2 Fastening part
4b Curved part
4B Heat insulating member
4Bb Curved part
4Ba 5-shaped part
4Ba-1 Holding part
4Ba-2 Fastening part
4Bb Curved part
5 Connector section
6 Case
6A Case
6B Case
6Ba Rib
6a Rib
7 Joint section
7a Circular slot
9a Circular slot
7b Horizontal end surface
7c Vertical end surface
8 End cap
8a Terminal
9 Joint section
10 Opening
20 Air space
21 Air space
30 Joint section
31 Main body
31a Circular slot
31b Supporting part
31c Supporting part
31d Supporting part
31e Tension part
32 Connector cover
32a Rib
32b Abutting part
100 Straight tube lamp
100A Straight tube lamp
100B Straight tube lamp

1. A straight tube lamp, comprising:
a substrate having a plurality of solid-state light emitting elements mounted thereon;
a heat dissipating member for dissipating heat from the substrate; and
a tubular case which contains the substrate and the heat dissipating member,
said straight tube lamp further comprising a heat insulating member provided between the heat dissipating member and the case.

2. The straight tube lamp according to claim 1, wherein the heat dissipating member is held by the heat insulating member so that the heat dissipating member is not in contact with the case.

3. The straight tube lamp according to claim 2, wherein opposite sides, each of which extends along a longitudinal direction of the case, of the heat dissipating member are held by opposite sides, each of which extends along the longitudinal direction, of the heat insulating member.

4. The straight tube lamp according to claim 1, wherein:
the heat insulating member has a part that is positioned between the heat dissipating member and the case; and
an air space is formed (i) between the heat insulating member and the heat dissipating member and/or (ii) between the heat insulating member and the case.

5. The straight tube lamp according to claim 1, wherein movement of the heat insulating member in a circumferential direction along an inner surface of the case is restrained and the heat insulating member is fastened to the case, by (i) protrusions which protrude from the inner surface of the case so as to make a pair and be flush with a plane parallel to a center axis of the case or (ii) protrusions which protrude toward the center axis of the case so as to make a pair.

6. The straight tube lamp according to claim 1, wherein:
the case has end members attached to its opposite ends along the longitudinal direction; and
the end members restrain movement of the heat insulating member relative to the case along the longitudinal direction.

7. The straight tube lamp according to claim 4, wherein the part of the heat insulating member, which part is positioned between the heat dissipating member and the case, has a shape that matches an inner peripheral surface of the case.

8. The straight tube lamp according to claim 1, wherein:
the heat dissipating member has, when cut along a plane perpendicular to the longitudinal direction of the case, a hat-shaped cross section including (i) a U-shaped part and (ii) flange parts on respective opposite sides of the U-shaped part; and
the substrate is attached to the bottom of a recess defined by the U-shaped part.

9. The straight tube lamp according to claim 1, wherein a wall of the case is thinner on a light-emitting side than on a backside.
